(19) United States
(12) Patent Application Publication
(10) Pub. No.: US 2015/0224424 A1
(43) Pub. Date: Aug. 13, 2015

(54) CONTAINER FOR USE IN STIRRING DEVICE, STIRRING DEVICE, AND METHOD FOR PRODUCING SEPARATOR FOR NONAQUEOUS ELECTROLYTE ELECTRICITY STORAGE DEVICES

(71) Applicant: NITTO DENKO CORPORATION, Ibaraki-shi, Osaka (JP)

(72) Inventors: Masaya Yano, Osaka (JP); Shunsuke Noumi, Osaka (JP)

(21) Appl. No.: 14/424,360

(22) PCT Filed: Aug. 5, 2013
(86) PCT No.: PCT/JP2013/004733

§ 371 Date: Feb. 26, 2015

(30) Foreign Application Priority Data
Aug. 27, 2012 (JP) 2012-186928

(51) Int. Cl. B01D 19/02; B65D 25/02; B65D 43/02; B65D 43/14; H01M 2/14; B65D 25/14

(52) U.S. Cl. CPC B01D 19/02; H01M 2/145; B65D 25/14; B65D 43/0225; B65D 43/14; B65D 25/02; B65D 2251/0018; B65D 2251/0081

(57) ABSTRACT

Provided is a container for use in a stirring device, the container including: an inner tubular portion (41) having a bottom and formed to have a cylindrically-shaped inner circumferential surface, the inner tubular portion capable of containing therein a material (11) for preparing an epoxy resin composition containing an epoxy resin, a curing agent, and a porogen; and a shaft portion (42) having a tubular or columnar shape and placed upright on a central region of an inner side of the bottom of the inner tubular portion (41). Further provided are a stirring device using the container and a method for producing a separator for nonaqueous electrolyte electricity storage devices.

### TECHNICAL FIELD

The present invention relates to a container for use in a stirring device, to a stirring device, and to a method for producing a separator for nonaqueous electrolyte electricity storage devices.

### BACKGROUND ART

The demand for nonaqueous electrolyte electricity storage devices, as typified by lithium-ion secondary batteries, lithium-ion capacitors etc., is increasing year by year against a background of various problems such as global environment conservation and depletion of fossil fuel. Porous polyolefin membranes are conventionally used as separators for nonaqueous electrolyte electricity storage devices. A porous polyolefin membrane can be produced by the method described below.

First, a solvent and a polyolefin resin are mixed and heated to prepare a polyolefin solution. The polyolefin solution is formed into a sheet shape by means of a metal mold such as a T-die, and the resulting product is discharged and cooled to obtain a sheet-shaped formed body. The sheet-shaped formed body is stretched, and the solvent is removed from the formed body. Thus, a porous polyolefin membrane is obtained. In the step of removing the solvent from the formed body, an organic solvent is used (see Patent Literature 1).

In the above production method, a halogenated organic compound such as dichloromethane is often used as the organic solvent. The use of a halogenated organic compound places a very large load on the environment, and has therefore been a problem.

By contrast, with a method described in Patent Literature 2 (a so-called dry method), a porous polyolefin membrane can be produced without use of a solvent that places a large load on the environment. However, this method has a problem in that control of the pore diameter of the porous membrane is difficult. In addition, there is also a problem in that when a porous membrane produced by this method is used as a separator for an electricity storage device, imbalance of ion permeation tends to occur inside the electricity storage device.

It is known that a method for producing a separator for nonaqueous electrolyte electricity storage devices has been provided in order to solve the problems as described above, the method including the steps of preparing an epoxy resin composition containing an epoxy resin, a curing agent, and a porogen; forming a cured product of the epoxy resin composition into a sheet shape so as to obtain an epoxy resin sheet; and removing the porogen from the epoxy resin sheet using a halogen-free solvent (see Patent Literature 3).

In this method, the porogen is removed from the epoxy resin sheet using a halogen-free solvent, and thus a porous epoxy resin membrane is obtained. Therefore, the use of a solvent that places a large load on the environment can be avoided. In addition, according to the invention described in Patent Literature 3, parameters such as the porosity and the pore diameter can be controlled relatively easily depending on the content and type of the porogen.

### CITATION LIST

### Patent Literature

Patent Literature 1: JP 2001-192487 A
Patent Literature 2: JP 2000-30683 A
Patent Literature 3: JP 4940367 B1

### SUMMARY OF INVENTION

### Technical Problem

According to the above-mentioned conventional method for producing a separator for nonaqueous electrolyte electricity storage devices, in the step of preparing an epoxy resin composition containing an epoxy resin, a curing agent, and a porogen, the epoxy resin composition containing the epoxy resin, the curing agent, and the porogen is first loaded into a container having a predetermined shape. Next, the solution of the epoxy resin composition loaded in the container is stirred, for example, by a stirring blade such as an anchor blade, and thus the solution of the epoxy resin composition is uniformly mixed. Subsequently, the stirring blade is removed out of the solution of the epoxy resin composition, then a mandrel (rotary shaft) for cutting process is inserted and fixed in the solution of the epoxy resin composition, and the epoxy resin is three-dimensionally crosslinked to fabricate a cylindrical tubular cured product of the epoxy resin composition.

In this case, in particular, since the solution containing the epoxy resin, the curing agent, and the porogen is a highly-viscous epoxy resin composition, there is a problem in that mixing performance achieved by stirring with an anchor blade is poor due to insufficient circulating flow in the vertical direction even if the anchor blade has a relatively large span and is rotated at a low speed.

Furthermore, when the above-mentioned stirring with an anchor blade is employed, it is necessary, after removing the stirring blade out of the solution of the epoxy resin composition, to insert and fix a mandrel (rotary shaft) for cutting process in the solution of the epoxy resin composition yet to be cured; therefore, the mixed state could be deteriorated at the time of removing the anchor blade or inserting the mandrel (rotary shaft).

The present invention aims to allow uniform stirring of a solution of an epoxy resin composition containing an epoxy resin, a curing agent, and a porogen when preparing the epoxy resin composition.

### Solution to Problem

The present invention provides a container for use in a stirring device that stirs a material placed in the container, the material being for preparing an epoxy resin composition containing an epoxy resin, a curing agent, and a porogen, the container including: a tubular portion having a bottom and formed to have a cylindrically-shaped inner circumferential surface, the tubular portion being capable of containing the material therein; and a shaft portion having a tubular or columnar shape and placed upright on a central region of an inner side of the bottom of the tubular portion.

In another aspect, the present invention provides a stirring device including: the container according to the present invention; a holding mechanism that holds the container; and a rotating mechanism that rotates the holding mechanism to stir the material.

In still another aspect, the present invention provides a method for producing a separator for nonaqueous electrolyte electricity storage devices, the method including the steps of: placing a material in the container according to the present invention and stirring the material with a stirring device, the material being for preparing an epoxy resin composition containing an epoxy resin, a curing agent, and a porogen; curing the material placed in the container and detaching the tubular portion from the cured material, thereby preparing a cured product of the epoxy resin composition in a cylindrical tubular shape; cutting a surface part of the cured product at a predetermined thickness while rotating the cured product about the shaft portion relative to a cutting blade, thereby forming the cured product into a sheet shape so as to obtain an epoxy resin sheet having a long strip shape; and removing the porogen from the epoxy resin sheet using a halogen-free solvent.

### Advantageous Effects of Invention

According to the present invention, a solution of an epoxy resin composition containing an epoxy resin, a curing agent, and a porogen is stirred by using a stirring device with a shaft portion placed upright in a container beforehand. Therefore, the solution of the epoxy resin composition can be uniformly stirred.

### BRIEF DESCRIPTION OF DRAWINGS

FIG. 1 is a schematic cross-sectional view of a nonaqueous electrolyte electricity storage device according to an embodiment of the present invention.

FIG. 2 is a schematic diagram of a cutting step.

FIG. 3 is a schematic diagram of an embodiment of a production system for carrying out a production method of the present invention.

FIG. 4 is an exploded perspective view of a container of a planetary centrifugal mixer used in a stirring step.

FIG. 5A is a schematic diagram of the stirring step.

FIG. 5B is a schematic diagram of the stirring step.

FIG. 5C is a schematic diagram of the stirring step.

FIG. 5D is a schematic diagram of the stirring step and a curing step.

FIG. 5E is a schematic diagram of the curing step.

FIG. 5F is a schematic diagram of the curing step.

FIG. 5G is a schematic diagram of the curing step.

FIG. 6 is a schematic diagram of the planetary centrifugal mixer.

FIG. 7 is an enlarged cross-sectional view of the container.

FIG. 8 is an exploded perspective view of a container of a planetary centrifugal mixer used in a stirring step according to another embodiment of the present invention.

FIG. 9A is a schematic diagram of the stirring step according to another embodiment of the present invention.

FIG. 9B is a schematic diagram of the stirring step according to another embodiment of the present invention.

FIG. 9C is a schematic diagram of the stirring step according to another embodiment of the present invention.

FIG. 9D is a schematic diagram of the stirring step and a curing step according to another embodiment of the present invention.

FIG. 10 is a schematic diagram of the planetary centrifugal mixer according to another embodiment of the present invention.

FIG. 11 is an enlarged cross-sectional view of the container according to another embodiment of the present invention.

FIG. 12 is an enlarged cross-sectional view of a container according to still another embodiment of the present invention.

### DESCRIPTION OF EMBODIMENTS

Hereinafter, an embodiment of the present invention will be described with reference to the accompanying drawings.

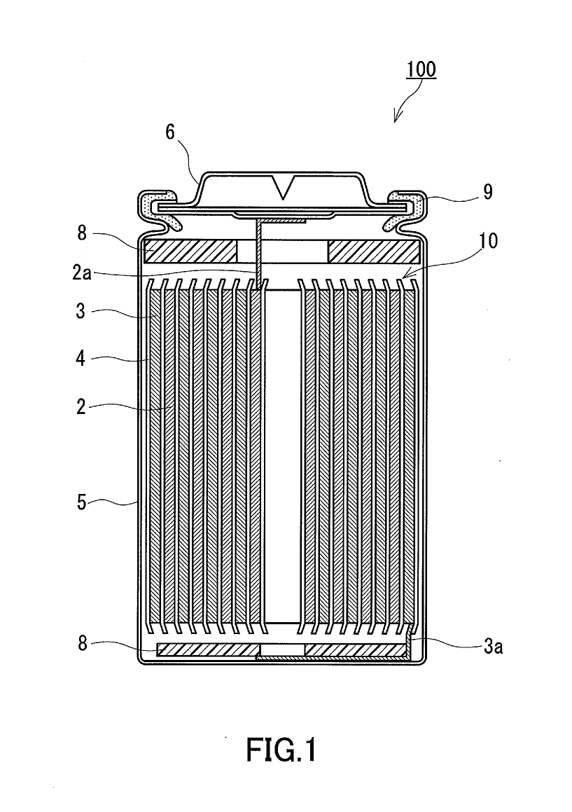

As illustrated in FIG. 1, a separator 4 for nonaqueous electrolyte electricity storage devices is disposed between a cathode 2 and an anode 3 in a nonaqueous electrolyte electricity storage device 100. The separator 4 serves to separate the cathode 2 and the anode 3 from each other, and also to ensure ion conductivity between the cathode 2 and the anode 3 by retaining an electrolyte solution (nonaqueous electrolyte solution). In the present embodiment, for example, a porous epoxy resin membrane produced by a method of making a block-shaped cured product 12 of an epoxy resin and forming the cured product 12 into a sheet shape is used as the separator for nonaqueous electrolyte electricity storage devices.

Specifically, first, a solution 11 of an epoxy resin composition containing an epoxy resin, a curing agent, and a porogen is loaded into a container 31 having a predetermined shape (e.g., a cylindrical tubular shape). Next, the solution 11 of the epoxy resin composition loaded in the container 31 is stirred by a planetary centrifugal mixer 22 with a shaft portion 42 fixed beforehand in the container 31, and thus the solution 11 of the epoxy resin composition is uniformly mixed. Thereafter, the epoxy resin is three-dimensionally crosslinked to fabricate a cylindrical tubular cured product 12 of the epoxy resin composition. At this time, a bicontinuous structure is formed as a result of phase separation between the crosslinked epoxy resin and the porogen. Thereafter, the surface part of the cured product 12 of the epoxy resin composition is cut at a predetermined thickness while the cured product 12 is rotated about a cylindrical tube axis O; thus, an epoxy resin sheet 16 having a long strip shape is fabricated. Subsequently, the epoxy resin sheet 16 is washed to remove the porogen contained in the sheet, and is then dried to obtain a porous epoxy resin membrane having a three-dimensional network structure and pores communicating with each other.

Hereinafter, the method for producing a separator for nonaqueous electrolyte electricity storage devices will be described in detail.

According to the above production method, the porous epoxy resin membrane can be produced through the following main steps.
Step (i): Preparing the epoxy resin composition.
Step (ii): Forming the cured product 12 of the epoxy resin composition into a sheet shape.
Step (iii): Removing the porogen from the epoxy resin sheet 16.

First, an epoxy resin composition containing an epoxy resin, a curing agent, and a porogen (pore-forming agent) is prepared. Specifically, a homogeneous solution 11 is prepared by dissolving the epoxy resin and the curing agent in the porogen.

As the epoxy resin, either an aromatic epoxy resin or a non-aromatic epoxy resin can be used. Examples of the aromatic epoxy resin include polyphenyl-based epoxy resins, epoxy resins containing a fluorene ring, epoxy resins containing triglycidyl isocyanurate, and epoxy resins containing a heteroaromatic ring (e.g., a triazine ring). Examples of the polyphenyl-based epoxy resins include bisphenol A-type epoxy resins, brominated bisphenol A-type epoxy resins, bisphenol F-type epoxy resins, bisphenol AD-type epoxy resins, stilbene-type epoxy resins, biphenyl-type epoxy resins, bisphenol A novolac-type epoxy resins, cresol novolac-type epoxy resins, diaminodiphenylmethane-type epoxy resins, and tetrakis(hydroxyphenyl)ethane-based epoxy resins. Examples of the non-aromatic epoxy resins include aliphatic glycidyl ether-type epoxy resins, aliphatic glycidyl ester-type epoxy resins, cycloaliphatic glycidyl ether-type epoxy resins, cycloaliphatic glycidylamine-type epoxy resins, and cycloaliphatic glycidyl ester-type epoxy resins. These may be used alone, or two or more thereof may be used in combination.

Among these, at least one that is selected from the group consisting of bisphenol A-type epoxy resins, brominated bisphenol A-type epoxy resins, bisphenol F-type epoxy resins, bisphenol AD-type epoxy resins, epoxy resins containing a fluorene ring, epoxy resins containing triglycidyl isocyanurate, cycloaliphatic glycidyl ether-type epoxy resins, cycloaliphatic glycidylamine-type epoxy resins, and cycloaliphatic glycidyl ester-type epoxy resins and that has an epoxy equivalent of 6000 or less and a melting point of 170° C. or lower, can be suitably used. The use of these epoxy resins allows a uniform three-dimensional network structure and uniform pores to be formed, and also allows excellent chemical resistance and high strength to be imparted to the porous epoxy resin membrane.

As the curing agent, either an aromatic curing agent or a non-aromatic curing agent can be used. Examples of the aromatic curing agent include aromatic amines (e.g., meta-phenylenediamine, diaminodiphenylmethane, diaminodiphenylsulfone, benzyldimethylamine, and dimethylaminomethylbenzene), aromatic acid anhydrides (e.g., phthalic anhydride, trimellitic anhydride, and pyromellitic anhydride), phenolic resins, phenolic novolac resins, and amines containing a heteroaromatic ring (e.g., amines containing a triazine ring). Examples of the non-aromatic curing agent include aliphatic amines (e.g., ethylenediamine, diethylenetriamine, triethylenetetramine, tetraethylenepentamine, iminobispropylamine, bis(hexamethylene)triamine, 1,3,6-trisaminomethylhexane, polymethylenediamine, trimethylhexamethylenediamine, and polyetherdiamine), cycloaliphatic amines (e.g., isophoronediamine, menthanediamine, N-aminoethylpiperazine, an adduct of 3,9-bis(3-aminopropyl)2,4,8,10-tetraoxaspiro(5,5)undecane, bis(4-amino-3-methylcyclohexyl)methane, bis(4-aminocyclohexyl)methane, and modified products thereof), and aliphatic polyamidoamines containing polyamines and dimer acids. These may be used alone, or two or more thereof may be used in combination.

Among these, a curing agent having two or more primary amines per molecule can be suitably used. Specifically, at least one selected from the group consisting of meta-phenylenediamine, diaminodiphenylmethane, diaminodiphenylsulfone, polymethylenediamine, bis(4-amino-3-methylcyclohexyl)methane, and bis(4-aminocyclohexyl)methane, can be suitably used. The use of these curing agents allows a uniform three-dimensional network structure and uniform pores to be formed, and also allows high strength and appropriate elasticity to be imparted to the porous epoxy resin membrane.

A preferred combination of an epoxy resin and a curing agent is a combination of an aromatic epoxy resin and an aliphatic amine curing agent, a combination of an aromatic epoxy resin and a cycloaliphatic amine curing agent, or a combination of a cycloaliphatic epoxy resin and an aromatic amine curing agent. These combinations allow excellent heat resistance to be imparted to the porous epoxy resin membrane.

The porogen can be a solvent capable of dissolving the epoxy resin and the curing agent. The porogen is used also as a solvent that can cause reaction-induced phase separation after the epoxy resin and the curing agent are polymerized. Specific examples of substances that can be used as the porogen include cellosolves such as methyl cellosolve and ethyl cellosolve, esters such as ethylene glycol monomethyl ether acetate and propylene glycol monomethyl ether acetate, glycols such as polyethylene glycol and polypropylene glycol, and ethers such as polyoxyethylene monomethyl ether and polyoxyethylene dimethyl ether. These may be used alone, or two or more thereof may be used in combination.

Among these, at least one selected from the group consisting of methyl cellosolve, ethyl cellosolve, polyethylene glycol having a molecular weight of 600 or less, ethylene glycol monomethyl ether acetate, propylene glycol monomethyl ether acetate, polypropylene glycol, polyoxyethylene monomethyl ether, and polyoxyethylene dimethyl ether, can be suitably used. In particular, at least one selected from the group consisting of polyethylene glycol having an average molecular weight of 200 or less, polypropylene glycol having a molecular weight of 500 or less, polyoxyethylene monomethyl ether, and propylene glycol monomethyl ether acetate, can be suitably used. The use of these porogens allows a uniform three-dimensional network structure and uniform pores to be formed. These may be used alone, or two or more thereof may be used in combination.

In addition, a solvent in which a reaction product of the epoxy resin and the curing agent is soluble can be used as the porogen even if the epoxy resin or the curing agent is individually insoluble or poorly-soluble in the solvent at ordinary temperature. Examples of such a porogen include a brominated bisphenol A-type epoxy resin (“Epicoat 5058” manufactured by Japan Epoxy Resin Co., Ltd).

The porosity, the average pore diameter, and the pore diameter distribution of the porous epoxy resin membrane vary depending on the types of the materials, the blending ratio of the materials, and reaction conditions (e.g., heating temperature and heating time at the time of reaction-induced phase separation). Therefore, in order to obtain the intended porosity, average pore diameter, and pore diameter distribution, optimal conditions are preferably selected. In addition, by controlling the molecular weight of the crosslinked epoxy resin, the molecular weight distribution, the viscosity of the solution, the cross-linking reaction rate etc. at the time of phase separation, a bicontinuous structure of the crosslinked epoxy resin and the porogen can be fixed in a particular state, and thus a stable porous structure can be obtained.

For example, the blending ratio of the curing agent to the epoxy resin is such that the curing agent equivalent is 0.6 to 1.5 per one epoxy equivalent. An appropriate curing agent equivalent contributes to improvement in the characteristics of the porous epoxy resin membrane, such as the heat resistance, the chemical durability, and the mechanical properties.

In order to obtain an intended porous structure, a curing accelerator may be added to the solution in addition to the curing agent. Examples of the curing accelerator include tertiary amines such as triethylamine and tributylamine, and imidazoles such as 2-phenol-4-methylimidazole, 2-ethyl-4-methylimidazole, and 2-phenol-4,5-dihydroxyimidazole.

For example, 40% by weight to 80% by weight of the porogen can be used relative to the total weight of the epoxy resin, the curing agent, and the porogen. The use of an appropriate amount of the porogen allows formation of a porous epoxy resin membrane having a desired porosity, average pore diameter, and air permeability.

One example of the method for adjusting the average pore diameter of the porous epoxy resin membrane within a desired range is to mix and use two or more types of epoxy resins having different epoxy equivalents. In that case, the difference between the epoxy equivalents is preferably 100 or more. In some cases, an epoxy resin that is liquid at ordinary temperature and an epoxy resin that is solid at ordinary temperature are mixed and used.

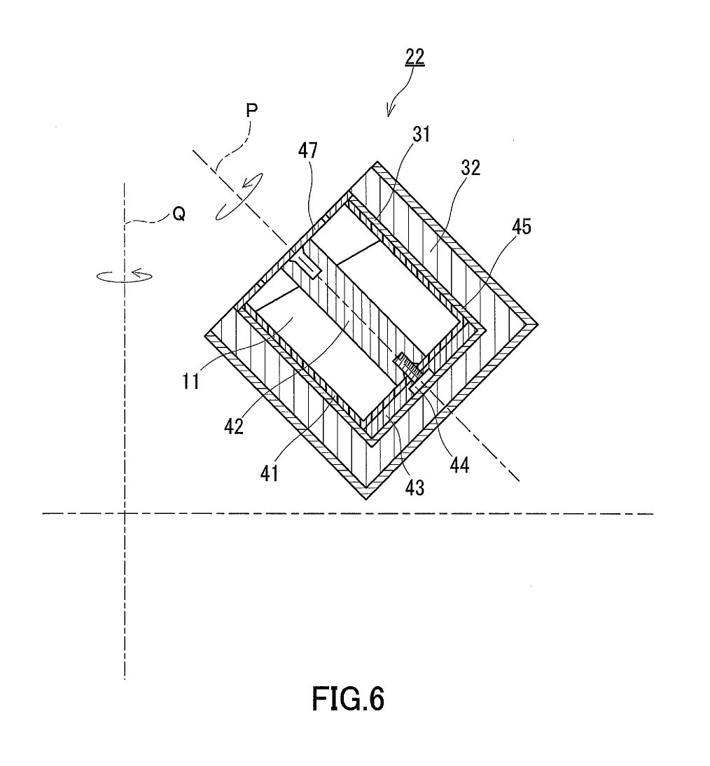

Next, the solution 11 of the epoxy resin composition containing the epoxy resin, the curing agent, and the porogen is stirred by the planetary centrifugal mixer 22 with the shaft portion 42 fixed beforehand in the container 31, and thus the solution 11 of the epoxy resin composition is uniformly mixed. Specifically, as shown in FIG. 6, the solution 11 containing the epoxy resin, the curing agent, and the porogen is loaded into the container 31 having a cylindrical tubular shape, the container 31 is held and fixed in the container holder 32, and then the container holder 32 is revolved around an revolution axis Q and simultaneously rotated about a rotation axis P by a rotating mechanism which is not illustrated. In this manner, the solution 11 of the epoxy resin composition is stirred. The rotating mechanism may cause the container holder 32 to revolve around the revolution axis Q and to simultaneously rotate about the rotation axis P, thereby stirring the solution 11 of the epoxy resin composition so as to defoam the solution 11. Alternatively, the rotating mechanism may cause the container holder 32 to revolve around the revolution axis Q, thereby stirring the solution 11 of the epoxy resin composition so as to defoam the solution 11. When the planetary centrifugal mixer 22 of the present embodiment is used, it is possible to perform the revolution alone by setting the rotation speed to 0. Alternatively, a stirring device capable of only the revolution may be used. The direction of the revolution around the revolution axis Q and the direction of the rotation about the rotation axis P are not limited to the directions indicated by arrows in FIG. 6, and may each be set to any given direction.

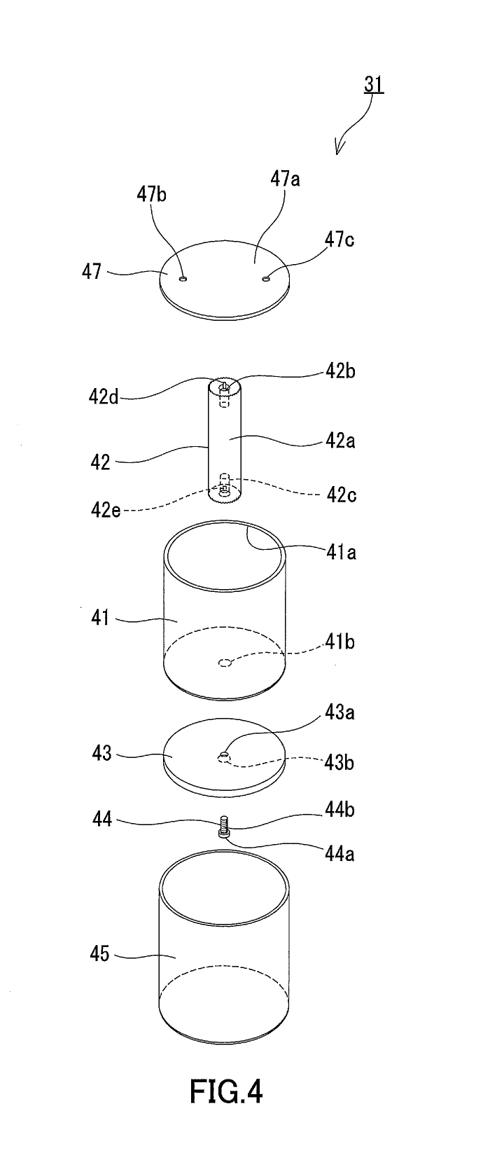

The container 31 for use in the planetary centrifugal mixer 22 is shown in FIGS. 4 to 7.

As shown in FIG. 4, the container 31 includes an inner tubular portion 41, the shaft portion 42, a plate member 43, a screw member 44, an outer tubular portion 45, and a lid member 47.

As shown in FIGS. 4, 5, and 7, the inner tubular portion 41 is a tubular member that has a bottom, that is formed to have a cylindrically-shaped inner circumferential surface 41a, that is capable of containing therein the solution 11 of the epoxy resin composition containing the epoxy resin, the curing agent, and the porogen, and that is made of a resin, as exemplified by a polyolefin resin such as polyethylene and polypropylene, a polyester resin such as PET (polyethylene terephthalate), polystyrene, and polycarbonate. The inner tubular portion 41 has a through hole 41b formed in the central region of the bottom and extending between the inner side and outer side of the bottom. A male threaded portion 44b of the screw member 44 described later can be inserted through the through hole 41b.

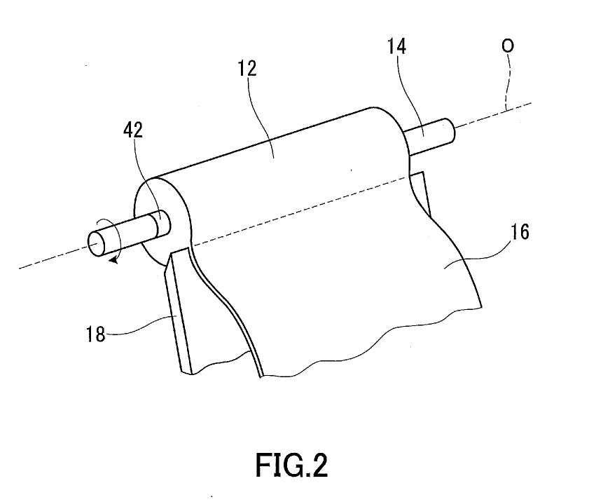

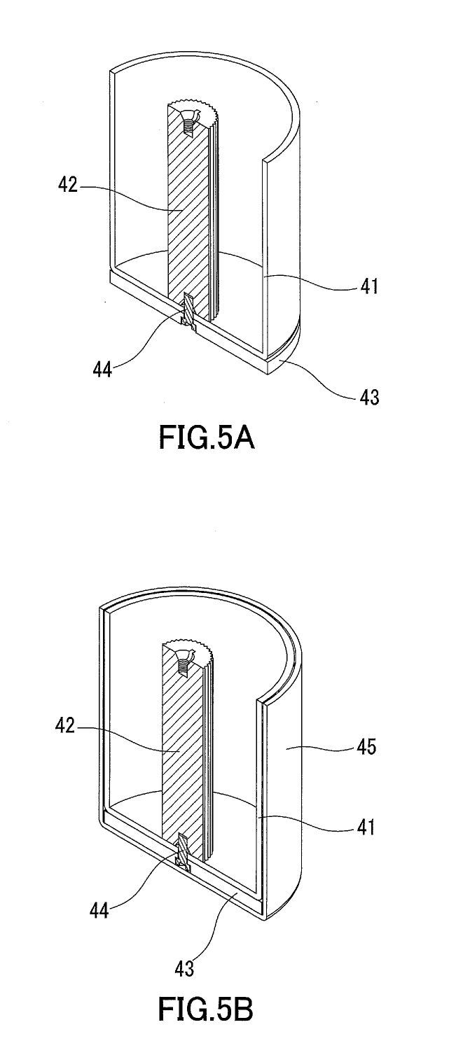

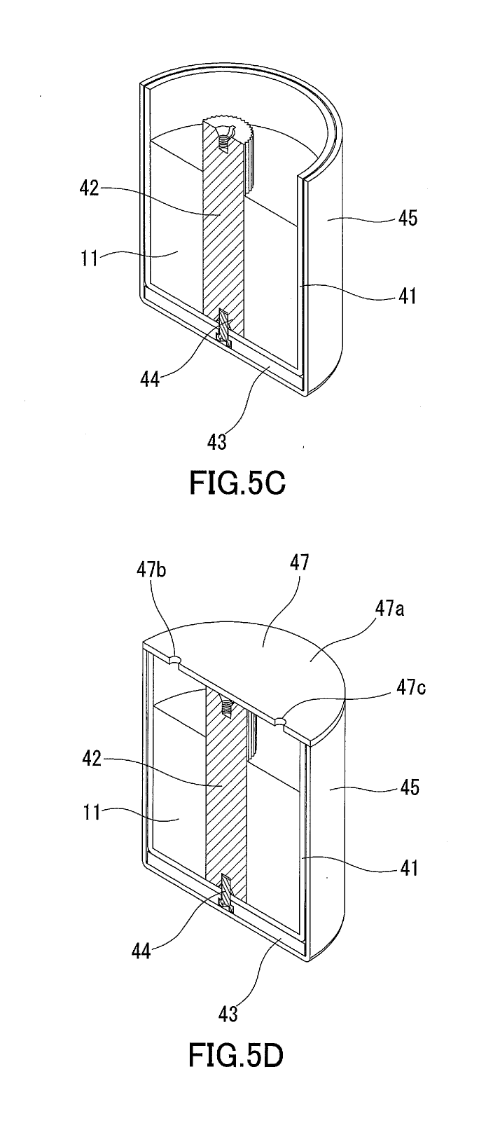

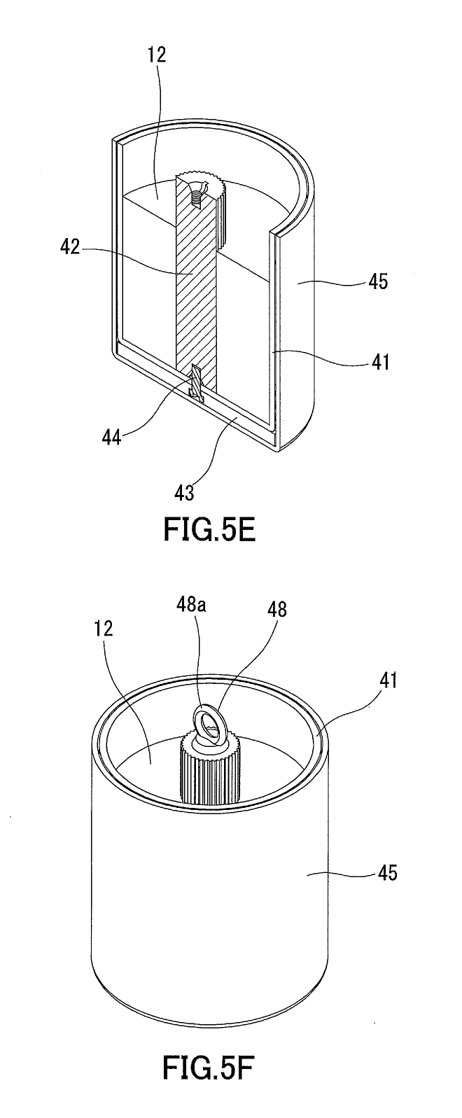

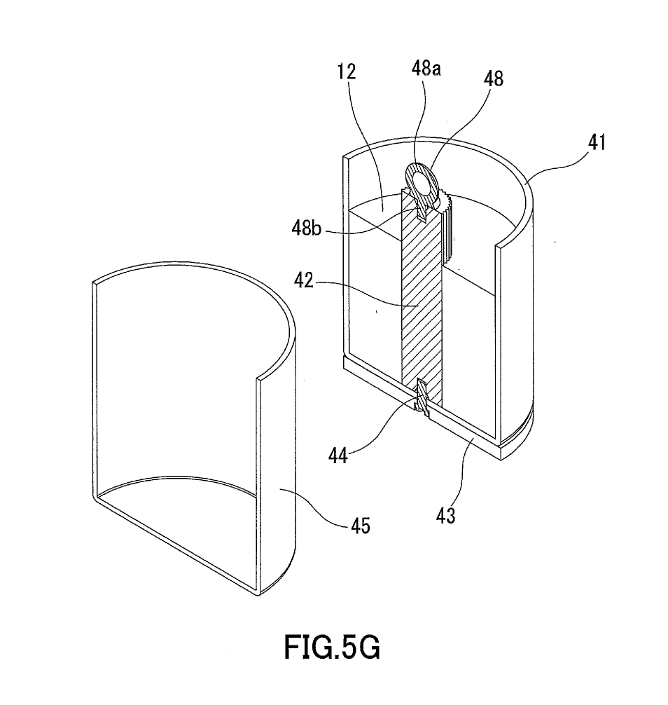

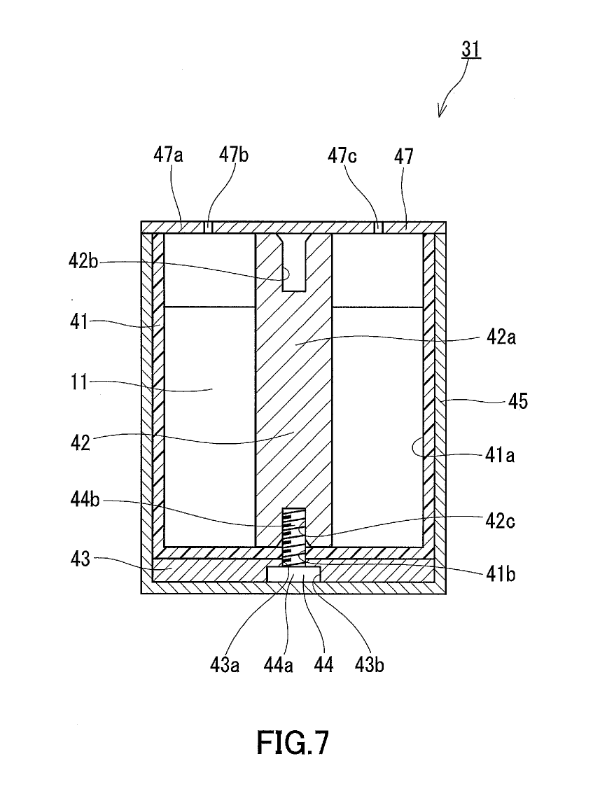

The shaft portion 42 is a tubular or columnar member placed upright on the central region of the inner side of the bottom of the inner tubular portion 41. As shown in FIGS. 4 and 7, the shaft portion 42 is a cylindrical tubular member or a cylindrical columnar member placed upright on the central region of the inner side of the bottom of the inner tubular portion 41. The shaft portion 42 is formed of a material that is lightweight and highly rigid. The shaft portion 42 may be a member made of a metal such as an aluminum alloy or may be a member made of a reinforced resin such as glass fiber-reinforced resin and carbon fiber-reinforced resin. The shaft portion 42 is a shaft member both ends of which are intended to be attached to a shaft 14 of a cutting device 24 described later, and the shaft portion 42 itself functions as a part of the shaft 14. The shaft portion 42 has: a shaft body 42a having a cylindrical columnar shape and extending in a longitudinal direction; a first female threaded portion 42b formed in a top end (the upper end in FIG. 4) of the shaft body 42a; and a second female threaded portion 42c formed in a base end (the lower end in FIG. 4) of the shaft body 42a. The first female threaded portion 42b is a female thread to which is screwed a male threaded portion 48b of a pull-out eye bolt 48 (see FIG. 5F) for detaching the cured product 12 from the outer tubular portion 45 after curing. The second female threaded portion 42c is a female thread to which the male threaded portion 44b of the screw member 44 is screwed. In this embodiment, the shaft portion 42, together with the plate member 43, is fixed to the inner tubular portion 41 by screwing the male threaded portion 44b of the screw member 44 to the second female threaded portion 42c of the shaft portion 42. In addition, as shown in FIG. 4, a first groove portion 42d and a second groove portion 42e having a non-circular (e.g., rectangular) axial cross-section are respectively formed in the openings of the first female threaded portion 42b and the second female threaded portion 42c. In order that the shaft portion 42 may be fixed to the shaft 14 (see FIG. 2) so as to be rotatable together with the shaft 14, the first groove portion 42d and the second groove portion 42e are adapted to engage with non-illustrated projecting portions each projecting radially from a part of the outer circumference of either end of the shaft 14. In this embodiment, it is possible to prevent the shaft portion 42 from idling about the shaft 14.

In another embodiment of the shaft portion 42, instead of the first female threaded portion 42b and the second female threaded portion 42c which are formed in the two ends of the shaft portion 42, groove portions having a non-circular inner shape may be formed in the ends of the shaft portion 42, and the ends of the shaft 14 may be formed as projecting portions having a non-circular outer shape so that the projecting portions engage with the groove portions. Alternatively, projecting portions having a non-circular outer shape may be formed in the ends of the shaft portion 42, and groove portions having a non-circular inner shape may be formed in the ends of the shaft 14. Alternatively, a groove portion having a non-circular inner shape may be formed in one end of the shaft portion 42, a projecting portion having a non-circular outer shape may be formed in one corresponding end of the shaft 14, a projecting portion having a non-circular outer shape may be formed in the other end of the shaft portion 42, and a groove portion having a non-circular inner shape may be formed in the other corresponding end of the shaft 14.

In still another embodiment of the shaft portion 42, the first female threaded portion 42b and the second female threaded portion 42c may be adapted to be screwed to male threaded portions of the shaft 14 which are not illustrated. Furthermore, threads oriented in such a manner that the shaft portion 42 and the shaft 14 are fastened together upon rotation of the shaft 14 may be formed in each of the first female threaded portion 42b and the second female threaded portion 42c. In this case, the shaft portion 42 is less likely to be detached from the shaft 14 when the shaft 14 is rotating. Alternatively, either or both of the female threaded portions (the first female threaded portion 42b and the second female threaded portion 42c) formed in the two ends of the shaft portion 42 may be replaced by a male threaded portion, and either or both of the male threaded portions of the shaft 14 may be replaced by a female threaded portion. Alternatively, the shaft portion 42 may be formed to further extend in the directions of its two ends so that the shaft portion 42 functions as the whole of the shaft 14.

The plate member 43 is a member provided on the bottom of the inner tubular portion 41 and fixed to the shaft portion 42. As shown in FIGS. 4 and 7, the plate member 43 is a circular plate member attached to the outer side of the bottom of the inner tubular portion 41. The plate member 43 is fixed to the base end of the shaft portion 42 by the screw member 44 in such a manner that the bottom of the inner tubular portion 41 is sandwiched. The plate member 43 is formed of a highly rigid material less prone to deformation. The plate member 43 may be a member made of a metal such as an aluminum alloy or may be a member made of a resin such as ultrahigh molecular weight polyethylene, PVC (polyvinyl chloride), polycarbonate, and a reinforced resin such as glass fiber-reinforced resin and carbon fiber-reinforced resin. The plate member 43 is a circular plate member having a diameter equal to or slightly larger than the diameter of the bottom of the inner tubular portion 41, and is formed to be thicker than the inner tubular portion 41. At the center of the plate member 43 is formed a stepped through hole extending between the inner side and outer side of the plate member 43. Specifically, as shown in FIG. 7, the plate member 43 has: a small-diameter hole 43a formed to have an opening on its side facing the outer side of the bottom of the inner tubular portion 41; and a large-diameter hole 43b communicating with the small-diameter hole 43a and formed to have an opening on its side opposite to the side facing the outer side of the bottom of the inner tubular portion 41. A head portion 44a of the screw member 44 described later is placed and locked in the large-diameter hole 43b, the male threaded portion 44b of the screw member 44 is inserted through the small-diameter hole 43a and the through hole 41b of the inner tubular portion 41, and the tip end of the male threaded portion 44b is screwed to the second female threaded portion 42c of the shaft portion 42. In this embodiment, the plate member 43 can be fixed to the shaft portion 42 without contact of the screw member 44 with the inner tubular portion 41 by bringing the head portion 44a of the screw member 44 into contact with the plate member 43.

The screw member 44 is a fixing means that fixes the plate member 43 to the shaft portion 42. As shown in FIGS. 4 and 7, the screw member 44 is a fastening member that fixes the plate member 43 to the shaft portion 42. The screw member 44 has: the head portion 44a having a large diameter; and the male threaded portion 44b formed to have a smaller diameter than the head portion 44a and screwed to the second female threaded portion 42c of the shaft portion 42. The head portion 44a is entirely placed within the large-diameter hole 43b of the plate member 43; therefore, when the inner tubular portion 41 to which the shaft portion 42 and the plate member 43 are fixed is contained in the outer tubular portion 45, the head portion 44a does not interfere with the outer tubular portion 45.

The outer tubular portion 45 is a tubular member having a bottom, made of a metal such as stainless steel, and capable of containing therein the inner tubular portion 41 to which the shaft portion 42 and the plate member 43 are fixed. The outer tubular portion 45 is formed to have an inner diameter equal to or slightly larger than the outer diameter of the inner tubular portion 41, and is capable of containing the inner tubular portion 41. The top surface (the upper surface in FIG. 4) of the outer tubular portion 45 is formed in such a manner that the top surface is flush with the top surface (the upper surface in FIG. 4) of the inner tubular portion 41 when the inner tubular portion 41 with the plate member 43 fixed thereto is contained in the outer tubular portion 45. Therefore, when the top opening of the inner tubular portion 41 is covered by the lid member 47, the lower surface of a lid body 47a of the lid member 47 described later is in flat contact with the top surfaces of the inner tubular portion 41 and the outer tubular portion 45.

At the time of stirring with the planetary centrifugal mixer 22, the outer tubular portion 45 is fixed in the container holder 32 by being held by its outer circumference as shown in FIG. 6. The outer tubular portion 45 is used until the cured product 12 of the epoxy resin composition is fabricated from the solution 11 containing the epoxy resin, the curing agent, and the porogen. After the curing, the inner tubular portion 41 containing the cured product 12 therein is taken out of the outer tubular portion 45.

As shown in FIGS. 4 and 7, the lid member 47 is a member that covers the opening of the inner tubular portion 41 and the top end of the shaft portion 42. The lid member 47 may be a member made of a metal such as an aluminum alloy or may be a member made of a resin such as ultrahigh molecular weight polyethylene, PVC (polyvinyl chloride), polycarbonate, and a reinforced resin such as glass fiber-reinforced resin and carbon fiber-reinforced resin. The lid member 47 has the disk-shaped lid body 47a and two through holes, that is, a first through hole 47b and a second through hole 47c extending through the lid body 47a. For example, the first through hole 47b and the second through hole 47c are disposed opposite to each other with respect to the center of the lid body 47a. The first through hole 47b is a circular through hole extending through the lid body 47a, and serves as a port for connection to a vacuuming device. The second through hole 47c is a circular through hole extending through the lid body 47a, and serves as a window for viewing the interior of the inner tubular portion 41 with an infrared camera device or a naked eye. The second through hole 47c may be closed by transparent glass or the like as long as the viewing is possible. The lid member 47 is provided to be contactable with the top end surface of the inner tubular portion 41 and the top end surface of the outer tubular portion 45. The lid body 47a is formed to have an outer diameter equal to or slightly larger than the outer diameter of the outer tubular portion 45, and is capable of closing the inner tubular portion 41 and the outer tubular portion 45 entirely. In another embodiment, the outer circumference of the surface (the lower surface in FIG. 4) of the lid body 47a that faces the opening of the inner tubular portion 41 may be provided with a cylindrical tubular locking portion projecting toward the outer tubular portion 45, and the cylindrical locking portion may be locked by a method, such as screw connection and elastic press-fit, in a corresponding locking portion provided on the outer circumference of the outer tubular portion 45 so that the lid member 47 is fixed to and seals the outer tubular portion 45.

Next, the method of preparing the homogeneous solution 11 by dissolving the epoxy resin and the curing agent in the porogen and of loading the solution 11 into the container 31 for use in the planetary centrifugal mixer 22 will be described by FIG. 5A to FIG. 5D.

First, as shown in FIG. 5A, the shaft portion 42 is placed upright on the central region of the inner side of the bottom of the inner tubular portion 41, with the plate member 43 attached to the outer side of the bottom of the inner tubular portion 41. The male threaded portion 44b of the screw member 44 is screwed to the second female threaded portion 42c of the shaft portion 42 to fix the shaft portion 42 to the inner tubular portion 41 and the plate member 43.

Next, as shown in FIG. 5B, the unit including the shaft portion 42, the inner tubular portion 41, and the plate member 43 which are integrated together is mounted to the interior of the outer tubular portion 45.

Next, as shown in FIG. 5C, the solution 11 of the epoxy resin composition containing the epoxy resin, the curing agent, and the porogen is loaded into the interior of the inner tubular portion 41. The loading amount of the solution 11 is not limited to that as shown in the figure, and can be set to any given loading amount.

Subsequently, as shown in FIG. 5D, the lid member 47 is attached to the top ends of the inner tubular portion 41 and the outer tubular portion 45 to close the opening of the inner tubular portion 41 and the top end of the shaft portion 42. The container 31, which includes the lid member 47, the shaft portion 42, the solution 11, the inner tubular portion 41, the plate member 43, the screw member 44, and the outer tubular portion 45 which are integrated together, is fixed in the container holder 32, and the solution 11 of the epoxy resin composition containing the epoxy resin, the curing agent, and the porogen is stirred by the planetary centrifugal mixer 22 to uniformly mix the solution 11 of the epoxy resin composition.

In this case, the solution 11 of the epoxy resin composition containing the epoxy resin, the curing agent, and the porogen is stirred by using the planetary centrifugal mixer 22 with the shaft portion 42 fixed beforehand in the container 31; therefore, the solution 11 of the epoxy resin composition can be uniformly stirred.

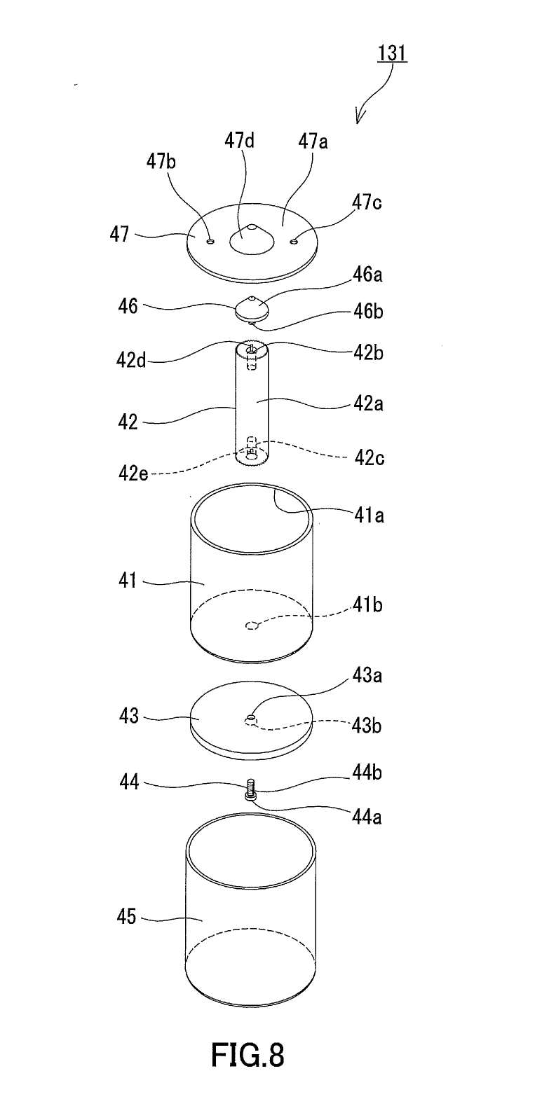

Next, another container 131 for use in the planetary centrifugal mixer 22 will be described by FIG. 8.

As shown in FIG. 8, the container 131 further includes a cover member 46. The other components except for the lid member 47 are the same as those of the above embodiment, and therefore the detailed description thereof is omitted.

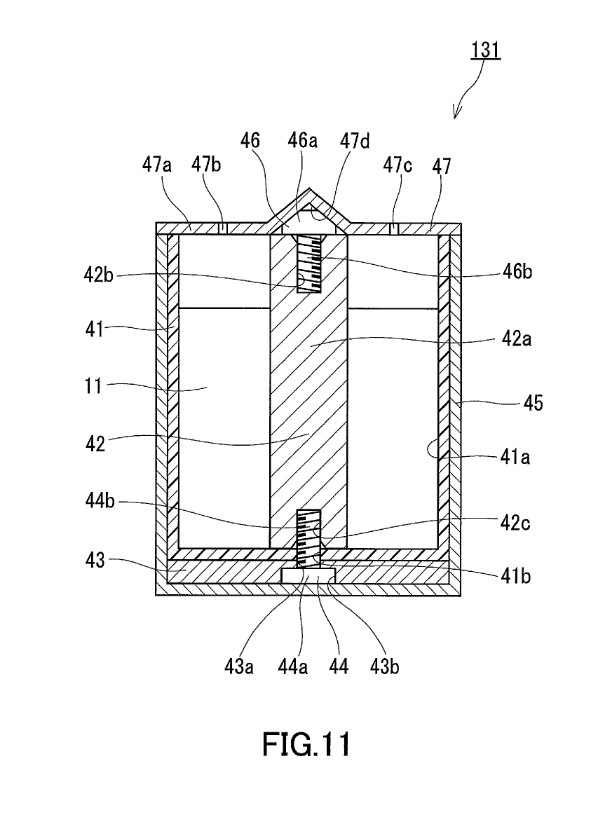

As shown in FIGS. 8 and 11, the cover member 46 is a screw member that closes the top end of the shaft portion 42, and is intended to prevent a situation in which the solution 11 of the epoxy resin composition containing the epoxy resin, the curing agent, and the porogen enters the first female threaded portion 42b formed in the top end of the shaft portion 42. The cover member 46 has: a head portion 46a formed in a shape having an outer circumferential surface whose diameter decreases toward the top end of the cover member; and a male threaded portion 46b formed to have a smaller diameter than the head portion 46a and capable of being screwed to the first female threaded portion 42b of the shaft portion 42. The head portion 46a is formed in a frusto-conical shape so as to have a small diameter on its top end side and a large diameter on its base end side. This makes it easier to load the solution 11 of the epoxy resin composition containing the epoxy resin, the curing agent, and the porogen into the inner tubular portion 41, with the cover member 46 attached to the shaft portion 42.

As shown in FIGS. 8 and 11, the lid member 47 is a member that covers the opening of the inner tubular portion 41 and the top end of the cover member 46. The lid member 47 further has a recess for fixing 47d formed by recessing the central region of the surface (the lower surface in FIG. 8) of the lid body 47a that faces the opening of the inner tubular portion 41. The recess for fixing 47d is a recess formed in a frusto-conical shape so as to be capable of receiving the top end of the head portion 46a of the cover member 46. The recess is created by forming the opposite side (the upper side in FIG. 8) as a projection having a frusto-conical shape. In this embodiment, when the inner tubular portion 41 and the outer tubular portion 45 are closed by the lid member 47, the top end of the head portion 46a of the cover member 46, which projects beyond the top end surfaces of the inner tubular portion 41 and the outer tubular portion 45, is fixed in the recess for fixing 47d; thus, the shaft portion 42 with the cover member 46 attached thereto is fixed. This makes it less likely that the shaft portion 42 is moved during stirring with the planetary centrifugal mixer 22. The recess for fixing 47d is not limited to that of the above embodiment; for example, the lid member 47 may be formed as a mesh member, and the head portion 46a of the cover member 46 or the top end of the shaft portion 42 may be locked and fixed by the meshes.

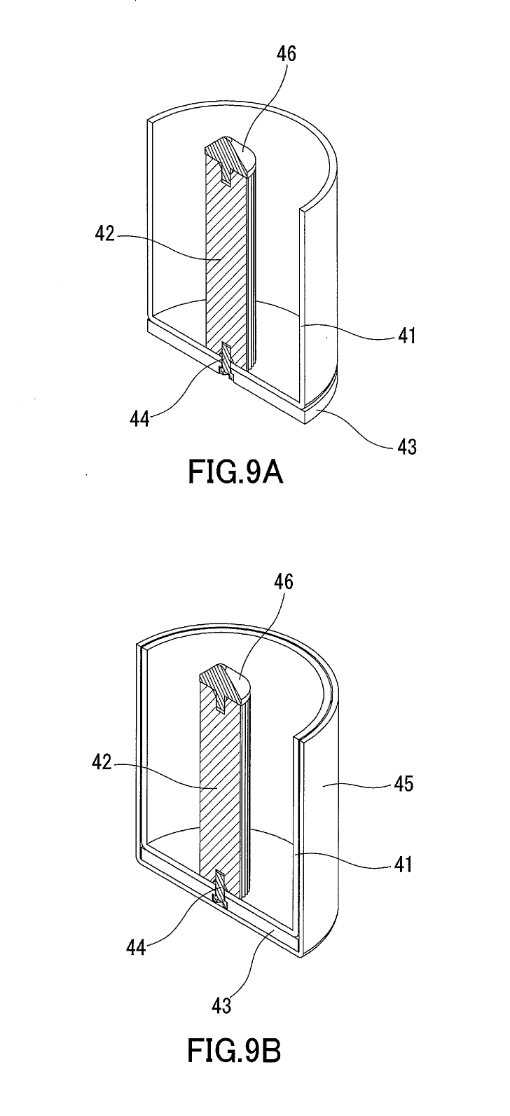

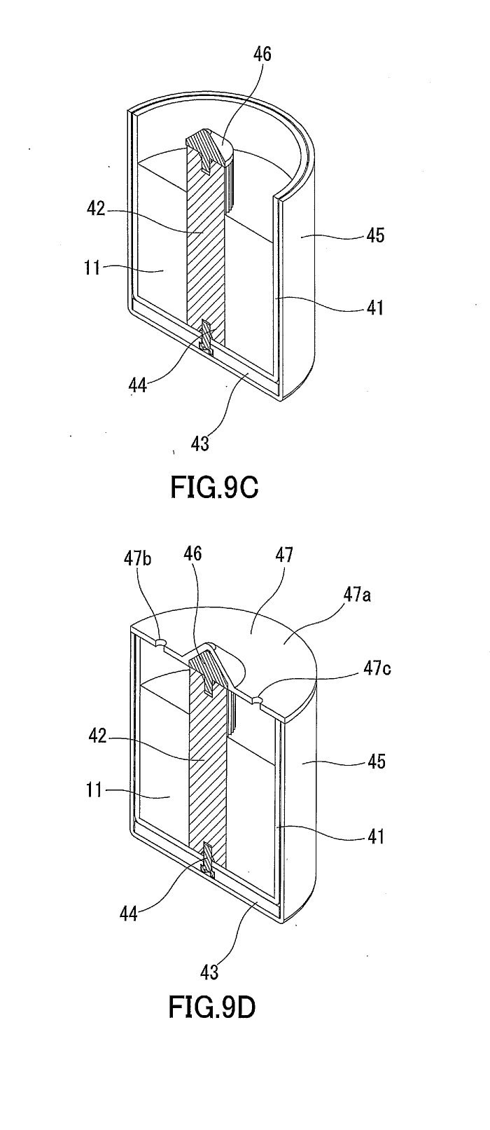

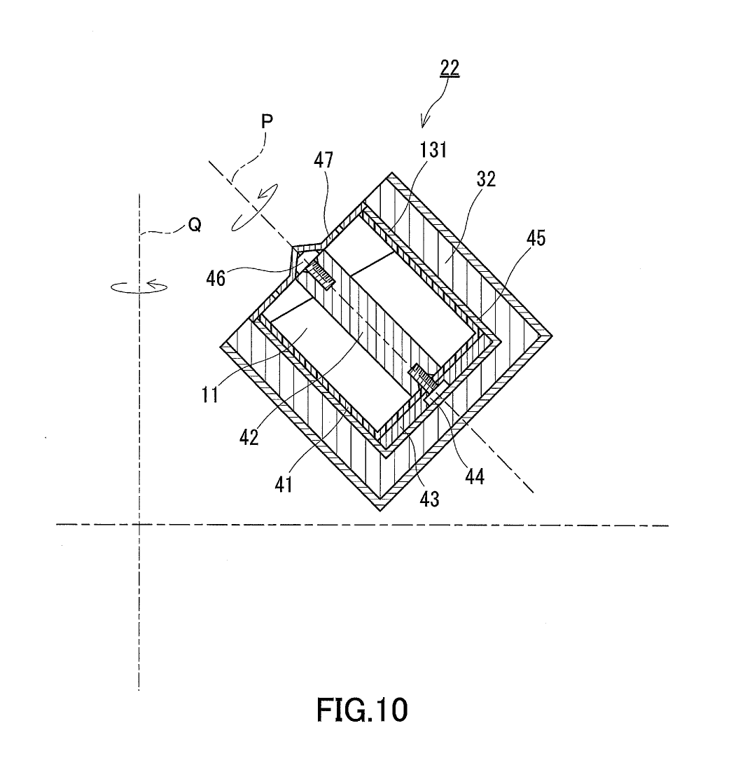

Next, the method of preparing the homogeneous solution 11 by dissolving the epoxy resin and the curing agent in the porogen and of loading the solution 11 into the container 131 for use in the planetary centrifugal mixer 22 will be described by FIG. 9A to FIG. 9D.

First, as shown in FIG. 9A, the shaft portion 42 is placed upright on the central region of the inner side of the bottom of the inner tubular portion 41, with the plate member 43 attached to the outer side of the bottom of the inner tubular portion 41. The male threaded portion 44b of the screw member 44 is screwed to the second female threaded portion 42c of the shaft portion 42 to fix the shaft portion 42 to the inner tubular portion 41 and the plate member 43. Then, the male threaded portion 46b of the cover member 46 is screwed to the first female threaded portion 42b of the shaft portion 42 to fix the cover member 46 to the shaft portion 42.

Next, as shown in FIG. 9B, the unit including the cover member 46, the shaft portion 42, the inner tubular portion 41, and the plate member 43 which are integrated together is mounted to the interior of the outer tubular portion 45.

Next, as shown in FIG. 9C, the solution 11 of the epoxy resin composition containing the epoxy resin, the curing agent, and the porogen is loaded into the interior of the inner tubular portion 41.

Subsequently, as shown in FIG. 9D, the lid member 47 is attached to the top ends of the inner tubular portion 41 and the outer tubular portion 45 to close the opening of the inner tubular portion 41 and the top end of the cover member 46. The container 131, which includes the lid member 47, the cover member 46, the shaft portion 42, the solution 11, the inner tubular portion 41, the plate member 43, the screw member 44, and the outer tubular portion 45 which are integrated together, is fixed in the container holder 32, and the solution 11 of the epoxy resin composition containing the epoxy resin, the curing agent, and the porogen is stirred by the planetary centrifugal mixer 22 to uniformly mix the solution 11 of the epoxy resin composition.

In this case, as in the above embodiment, the solution 11 of the epoxy resin composition containing the epoxy resin, the curing agent, and the porogen is stirred by using the planetary centrifugal mixer 22 with the shaft portion 42 fixed beforehand in the container 131; therefore, the solution 11 of the epoxy resin composition can be uniformly stirred.

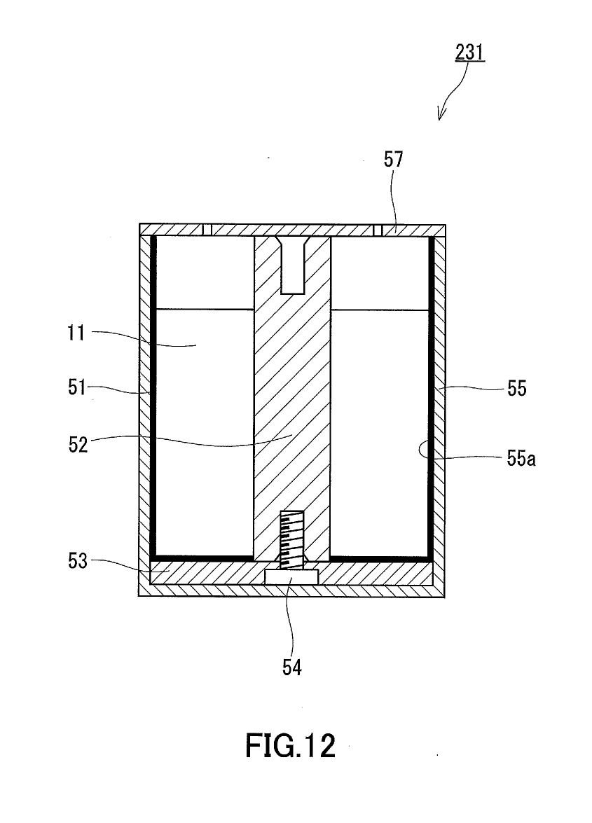

Next, another container 231 for use in the planetary centrifugal mixer 22 will be described by FIG. 12.

As shown in FIG. 12, the container 231 includes a release agent layer 51, a shaft portion 52, a plate member 53, a screw member 54, an outer tubular portion 55, and a lid member 57. The main differences from the above embodiments are that the release agent layer 51 is provided instead of the inner tubular portion 41, that the plate member 53 is attached to the inner side of the bottom of the outer tubular portion 55, and that the outer tubular portion 55 is formed to have a cylindrically-shaped inner circumferential surface 55a. The other features are the same as those of the above embodiments, and therefore the detailed description thereof is omitted.

The release agent layer 51 is applied to the inner circumferential surface 55a of the outer tubular portion 55 in order to make it easy to detach from the outer tubular portion 55 the cured product 12 fabricated by curing the solution 11 of the epoxy resin composition containing the epoxy resin, the curing agent, and the porogen. For example, the release agent layer 51 is formed by thinly applying a release agent (QZ-13 manufactured by Nagase ChemteX Corporation) to the inner circumferential surface 55a of the outer tubular portion 55 and then drying the outer tubular portion 55 in a dryer set at 80° C.

In this case, as in the above embodiments, the solution 11 of the epoxy resin composition containing the epoxy resin, the curing agent, and the porogen is stirred by using the planetary centrifugal mixer 22 with the shaft portion 42 fixed beforehand in the container 231; therefore, the solution 11 of the epoxy resin composition can be uniformly stirred.

Next, the cured product 12 of the epoxy resin composition is fabricated from the solution 11 containing the epoxy resin, the curing agent, and the porogen. Specifically, the container 31 loaded with the solution 11 having been stirred is detached from the container holder 32 of the planetary centrifugal mixer 22, then heated as necessary, and left for a predetermined time with a predetermined temperature maintained. The epoxy resin is three-dimensionally crosslinked to obtain the cured product 12 having a cylindrical tubular shape. At this time, a bicontinuous structure is formed as a result of phase separation between the crosslinked epoxy resin and the porogen.

The dimensions of the cured product 12 having a cylindrical tubular shape are not particularly limited. The diameter of the cured product 12 is, for example, 20 cm or more, and preferably 30 to 150 cm from the standpoint of the efficiency of the production of the porous epoxy resin membrane. The length (in the axial direction) of the cured product can also be set as appropriate in consideration of the dimensions of the porous epoxy resin membrane to be obtained. The length of the cured product is, for example, 10 to 200 cm. From the standpoint of handleability, the length is preferably 10 to 150 cm, and more preferably 10 to 120 cm.

Next, the method of fabricating the cured product 12 of the epoxy resin composition from the solution 11 containing the epoxy resin, the curing agent, and the porogen will be described by FIG. 5D to FIG. 5G.

After stirring with the planetary centrifugal mixer 22, first, the container 31 loaded with the solution 11 of the epoxy resin composition as shown in FIG. 5D is put in and heated by a heating device 23, and is left for a predetermined time with a predetermined temperature maintained. Thus, the cured product 12 of the epoxy resin composition is fabricated.

Next, as shown in FIG. 5E, the lid member 47 is detached from the top ends of the inner tubular portion 41 and the outer tubular portion 45.

Next, as shown in FIG. 5F, to the top end of the shaft portion 42 is attached the eye bolt 48 for pulling out from the outer tubular portion 45 the unit including the shaft portion 42, the cured product 12, the inner tubular portion 41, the plate member 43, and the screw member 44 which are integrated together. The eye bolt 48 has: an operation portion 48a for pull-out operation provided on the top end side; and a male threaded portion 48b formed at the base end of the operation portion 48a and capable of being screwed to the first female threaded portion 42b of the shaft portion 42 (see FIG. 5G). For example, the operation portion 48a is an annular member, and can be pulled in the direction of the top end. In another embodiment, the operation portion 48a may be formed in any given shape as long as it can be pulled in the direction of the top end. An eye nut may be provided instead of the eye bolt 48, and a male threaded portion may be formed in the top end of the shaft portion 42 so that the female threaded portion of the eye nut is screwed to the male threaded portion. Alternatively, the unit including the shaft portion 42, the cured product 12, the inner tubular portion 41, the plate member 43, and the screw member 44 which are integrated together may be detached from the outer tubular portion 45 without attaching the eye bolt 48.

As shown in FIG. 5G, the unit including the shaft portion 42, the cured product 12, the inner tubular portion 41, the plate member 43, and the screw member 44 which are integrated together is pulled out from the outer tubular portion 45 by pulling the operation portion 48a of the eye bolt 48 in the direction of the top end. The eye bolt 48, the inner tubular portion 41, the plate member 43, and the screw member 44 are detached from the shaft portion 42 and the cured product 12, and thus the cured product 12 having a cylindrical tubular shape is fabricated.

Next, the cured product 12 is formed into a sheet shape. The cured product 12 having a cylindrical tubular shape can be formed into a sheet shape by the following method. Specifically, as shown in FIG. 2, the two ends of the shaft portion 42 integrated with the cured product 12 are attached to the shaft 14 of the cutting device 24. The surface part of the cured product 12 is cut (sliced) at a predetermined thickness using a cutting blade (slicer) 18 so that an epoxy resin sheet 16 having a long strip shape is obtained. More specifically, the surface part of the cured product 12 is skived while the cured product 12 is rotated about the cylindrical tube axis O of the cured product 12 relative to the cutting blade 18. The position of the cutting blade 18 relative to the cylindrical tube axis O of the cured product 12 is controlled so that the cutting blade 18 moves closer to the cylindrical tube axis O by a predetermined distance during one rotation of the cured product 12 relative to the cutting blade 18. This predetermined distance corresponds to the cutting thickness. With this method, the epoxy resin sheet 16 having a predetermined thickness can be fabricated efficiently.

The line speed during skiving of the cured product 12 is in the range of, for example, 2 to 70 m/min. The thickness of the epoxy resin sheet 16 is determined depending on a target membrane thickness (e.g., 5 to 50 μm, or 10 to 50 μm) of the porous epoxy resin membrane. Removal of the porogen and the subsequent drying slightly reduce the thickness. Therefore, the epoxy resin sheet 16 generally has a thickness slightly greater than the target membrane thickness of the porous epoxy resin membrane. The length of the epoxy resin sheet 16 is not particularly limited. From the standpoint of the efficiency of the production of the epoxy resin sheet 16, the length is, for example, 100 m or more, and preferably 1000 m or more.

Finally, the porogen is extracted and removed from the epoxy resin sheet 16. Specifically, the porogen can be removed from the epoxy resin sheet 16 by immersing the epoxy resin sheet 16 in a halogen-free solvent. Thus, the porous epoxy resin membrane that can be used as the separator 4 is obtained.

As the halogen-free solvent for removing the porogen from the epoxy resin sheet 16, at least one selected from the group consisting of water, DMF (N,N-dimethylformamide), DMSO (dimethylsulfoxide), and THF (tetrahydrofuran), can be used depending on the type of the porogen. In addition, a supercritical fluid of water, carbon dioxide, or the like, can also be used as the solvent for removing the porogen. In order to actively remove the porogen from the epoxy resin sheet 16, vibration washing such as ultrasonic washing may be performed, or the solvent may be heated before use.

The type of a washing device for removing the porogen is not particularly limited either, and a commonly-known washing device can be used. In the case where the porogen is removed by immersing the epoxy resin sheet 16 in a solvent, a multi-stage washer having a plurality of washing tanks can be suitably used. The number of stages of washing is more preferably three or more. In addition, washing that substantially corresponds to multi-stage washing may be performed by means of counterflow. Furthermore, the temperature of the solvent or the type of the solvent may be changed for each stage of washing.

After removal of the porogen, the porous epoxy resin membrane is subjected to a drying process. The conditions of drying are not particularly limited. The temperature is generally about 40 to 120° C., and preferably about 50 to 80° C. The drying time is about 30 seconds to 3 hours. For the drying process, a dryer can be used that employs a commonly-known sheet drying method, such as a tenter method, a floating method, a roll method, and a belt method. A plurality of drying methods may be combined.

With the method of the present embodiment, the porous epoxy resin membrane usable as the separator 4 can be produced very easily. Since some step such as a stretching step required for production of conventional porous polyolefin membranes can be omitted, the porous epoxy resin membrane can be produced with high productivity. In addition, since a conventional porous polyolefin membrane is subjected to high temperature and high shear force during the production process, an additive such as an antioxidant needs to be used. By contrast, with the method of the present embodiment, the porous epoxy resin membrane can be produced without being subjected to high temperature and high shear force. Therefore, the need for use of an additive such as an antioxidant as contained in a conventional porous polyolefin membrane can be eliminated. Furthermore, since inexpensive materials can be used as the epoxy resin, the curing agent, and the porogen, the production cost of the separator 4 can be reduced.

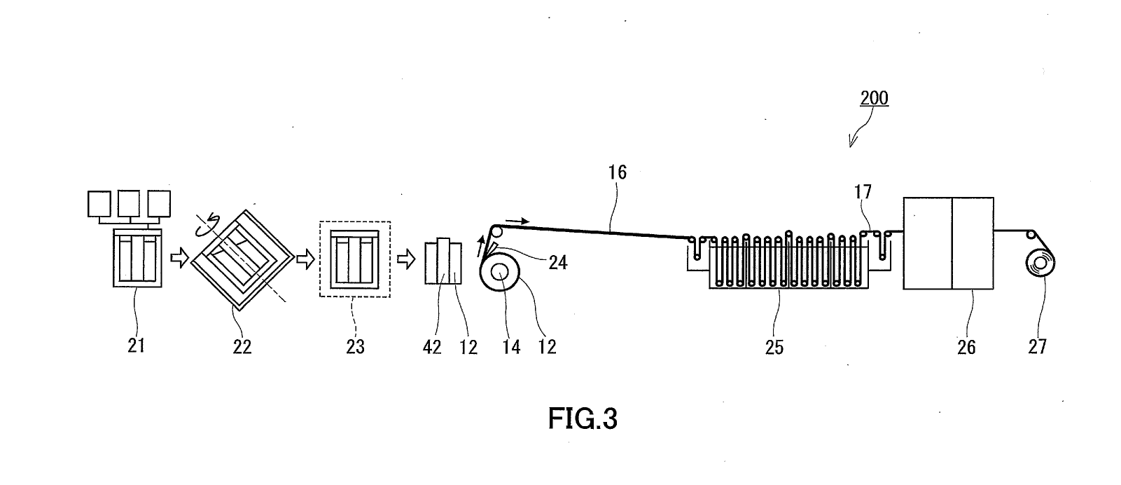

The production method of the present embodiment can be suitably carried out using a production system 200 of separators for nonaqueous electrolyte electricity storage devices which is shown in FIG. 3.

The production system 200 shown in FIG. 3 includes a mixing device 21, the planetary centrifugal mixer 22, the heating device 23, the cutting device 24, a washing tank 25, a dryer 26, and a winding device 27. The mixing device 21 is a device that mixes the epoxy resin, the curing agent, and the porogen to prepare the epoxy resin composition. The planetary centrifugal mixer 22 is a device that stirs the solution 11 of the epoxy resin composition containing the epoxy resin, the curing agent, and the porogen. The heating device 23 is a device that cures the solution 11 of the epoxy resin composition containing the epoxy resin, the curing agent, and the porogen. The cutting device 24 is a device intended to form the cured product 12 of the epoxy resin composition containing the epoxy resin, the curing agent, and the porogen into a sheet shape. The washing tank 25 is a device intended to remove the porogen from the epoxy resin sheet 16 and holding a halogen-free solvent for removing the porogen. The dryer 26 is a dryer that dries the porous epoxy resin membrane resulting from the removal of the porogen. The winding device 27 is a device that winds the epoxy resin sheet 16 into a roll. The devices are connected in the order in which they are mentioned above.

First, in the mixing device 21, the homogeneous solution 11 is prepared by dissolving the epoxy resin and the curing agent in the porogen. Next, in the planetary centrifugal mixer 22, the solution 11 of the epoxy resin composition containing the epoxy resin, the curing agent, and the porogen is stirred by the planetary centrifugal mixer 22 with the shaft portion 42 fixed beforehand in the container 31, and thus the solution 11 of the epoxy resin composition is uniformly mixed.

Next, the container 31 loaded with the solution 11 of the epoxy resin composition is put in and heated by the heating device 23, and is left for a predetermined time with a predetermined temperature maintained. The epoxy resin is three-dimensionally crosslinked to fabricate the cured product 12 that has a cylindrical tubular shape and in the center of which the shaft portion 42 is integrally fixed. An embodiment different from the production system 200 may be employed in which the heating device 23 is not used and the container 31 is left for a predetermined time in a room temperature environment such as in a room.

Next, the cylindrical tubular cured product 12 of the epoxy resin composition that has been obtained in the heating device 23 and in the center of which the shaft portion 42 is integrally fixed is set to the cutting device 24 having the cutting blade 18 and a rotating device. Specifically, the two ends of the shaft portion 42 are fixed to the shaft 14 in such a manner that the shaft portion 42 is rotatable together with the shaft 14; thus, the shaft portion 42 and the cylindrical tubular cured product 12 of the epoxy resin composition rotate in response to rotation of the shaft 14. The cutting device 24 cuts the surface part of the cured product 12 while rotating the cured product 12 with the rotating device about the cylindrical tube axis O of the cured product 12 relative to the cutting blade 18. Thus, the surface part of the cylindrical tubular cured product 12 is cut at a predetermined thickness, and the epoxy resin sheet 16 having a long strip shape is continuously formed.

Subsequently, the epoxy resin sheet 16 continuously formed by the cutting device 24 is transported to the washing tank 25. The washing tank 25 is filled with a halogen-free solvent for removing the porogen. The epoxy resin sheet 16 passes through the washing tank 25, so that the porogen is removed. The porous epoxy resin membrane resulting from the removal of the porogen is dried in the dryer 26, and wound into a roll by the winding device 27. An embodiment different from the production system 200 can be employed in which the cutting device 24 is not connected to the washing tank 25, the epoxy resin sheet 16 obtained as a result of cutting by the cutting device 24 is wound into a sheet roll by the winding device 27, and then the sheet roll is wound off to transport the epoxy resin sheet 16 to the washing tank 25.

### EXAMPLES

Hereinafter, the present invention will be described in more detail with reference to an example. However, the present invention is not limited to the example.

An epoxy resin-polypropylene glycol solution 11 was prepared by dissolving 100 parts by weight of a bisphenol A-type epoxy resin (j ER 828 manufactured by Mitsubishi Chemical Corporation and having an epoxy equivalent of 184 to 194 g/eq.) in 147 parts by weight of polypropylene glycol (SANNIX PP-400 manufactured by Sanyo Chemical Industries, Ltd.). This solution 11 was then added to a cylindrical tubular container 31 having dimensions of 120 mm (inner diameter)×150 mm. Thereafter, 15 parts by weight of 1,6-diaminohexane (special grade, manufactured by Tokyo Chemical Industry Co., Ltd.) was added into the container 31.

The solution was stirred for 120 minutes using the planetary centrifugal mixer 22 (trade name “Awatori Rentaro” (registered trademark) manufactured by THINKY CORPORATION) at a revolution speed of 200 rpm and a rotation speed of 150 rpm while vacuuming was performed using a vacuuming device through the first through hole 47b at a pressure of 0.75 kPa. The temperature of the solution was increased by the stirring, and reached 75° C. Thereafter, the container 31 was transferred to a constant-temperature chamber set at 75° C., and left for half a day, so that an epoxy resin block was obtained. If the vacuum drawing is not performed, stirring may be performed for 115 minutes using the planetary centrifugal mixer 22 at a revolution speed of 200 rpm and a rotation speed of 150 rpm, and then stirring may be performed for 5 minutes using the planetary centrifugal mixer 22 at a revolution speed of 400 rpm without rotation (at a rotation speed of 0 rpm).

Next, the epoxy resin block was taken out of the container 31, and was continuously sliced at a thickness of 30 μm using a cutting lathe to obtain an epoxy resin sheet. The epoxy resin sheet was washed with a mixed liquid of RO water and DMF (v/v=1/1) under ultrasonic wave for 10 minutes, then washed with only RO water under ultrasonic wave for 10 minutes, and immersed in RO water for 12 hours to remove the polypropylene glycol. Thereafter, drying at 80° C. was performed for 2 hours, and thus a porous epoxy resin membrane was obtained.

### INDUSTRIAL APPLICABILITY

The porous epoxy resin membrane provided by the present invention can be suitably used as a separator for nonaqueous electrolyte electricity storage devices such as lithium-ion secondary batteries, and can be suitably used in particular for high-capacity secondary batteries required for vehicles, motorcycles, ships, construction machines, industrial machines, and residential electricity storage systems. In addition, the porous epoxy resin membrane provided by the present invention can be used as a porous support of a composite semipermeable membrane composed of the porous support and a skin layer formed on the support.

1. A container for use in a stirring device that stirs a material placed in the container, the material being for preparing an epoxy resin composition containing an epoxy resin, a curing agent, and a porogen, the container comprising:
a tubular portion having a bottom and formed to have a cylindrically-shaped inner circumferential surface, the tubular portion being capable of containing the material therein; and
a shaft portion having a tubular or columnar shape and placed upright on a central region of an inner side of the bottom of the tubular portion.

2. The container for use in a stirring device according to claim 1, further comprising:
a plate member provided on the bottom of the tubular portion and fixed to the shaft portion; and
a fixing means that fixes the plate member to the shaft portion.

3. The container for use in a stirring device according to claim 2, wherein
the tubular portion is an inner tubular portion,
the plate member is attached to an outer side of the bottom of the inner tubular portion, and is fixed to a base end of the shaft portion by the fixing means in such a manner that the bottom of the inner tubular portion is sandwiched, and
the container further comprises an outer tubular portion having a bottom and capable of containing therein the shaft portion, the inner tubular portion, and the plate member.

4. The container for use in a stirring device according to claim 3, wherein the inner tubular portion is made of a resin.

5. The container for use in a stirring device according to claim 2, wherein
the tubular portion is an outer tubular portion capable of containing the plate member therein,
the plate member is attached to the inner side of the bottom of the outer tubular portion, and is fixed to a base end of the shaft portion by the fixing means, and
the container further comprises a release agent layer formed on the inner circumferential surface of the outer tubular portion.

6. The container for use in a stirring device according to claim 5, wherein the outer tubular portion is made of a metal.

7. The container for use in a stirring device according to claim 2, wherein the fixing means has:
a first threaded portion formed in a base end of the shaft portion; and
a second threaded portion capable of being screwed to the first threaded portion.

8. The container for use in a stirring device according to claim 1, further comprising a cover member closing at least a top end of the shaft portion.

9. The container for use in a stirring device according to claim 8, wherein
the shaft portion has a third threaded portion formed in the top end, and
the cover member has a fourth threaded portion capable of being screwed to the third threaded portion.

10. The container for use in a stirring device according to claim 9, further comprising a pull-out member having:
an operation portion for pull-out operation provided on a top end side of the pull-out member; and
a fifth threaded portion formed on a base end side of the pull-out member and capable of being screwed to the third threaded portion.

11. The container for use in a stirring device according to claim 8, wherein the cover member is formed in a shape having an outer circumferential surface whose diameter decreases toward a top end of the cover member.

12. The container for use in a stirring device according to claim 1, further comprising a fixing member that fixes a top end of the shaft portion.

13. The container for use in a stirring device according to claim 8, further comprising a lid member covering an opening of the tubular portion and a top end of the cover member.

14. The container for use in a stirring device according to claim 13, wherein
the cover member is fixed to the top end of the shaft portion, and
the lid member has a fixing recess formed to be capable of fixing the top end of the cover member.

15. The container for use in a stirring device according to claim 1, wherein the shaft portion is a cylindrical tubular member or a cylindrical columnar member.

16. The container for use in a stirring device according to claim 2, wherein the plate member is a circular plate member.

17. A stirring device comprising:
the container according to claim 1;
a holding mechanism that holds the container; and
a rotating mechanism that rotates the holding mechanism to stir the material.

18. The stirring device according to claim 17, wherein the rotating mechanism causes the holding mechanism to revolve in an orbit, thereby stirring the material so as to defoam the material.

19. The stirring device according to claim 18, wherein the rotating mechanism causes the holding mechanism to revolve in an orbit and to simultaneously rotate about its axis, thereby stirring the material so as to defoam the material.

20. A method for producing a separator for nonaqueous electrolyte electricity storage devices, comprising the steps of:
placing a material in the container according to claim 1 and stirring the material with a stirring device, the material being for preparing an epoxy resin composition containing an epoxy resin, a curing agent, and a porogen;
curing the material placed in the container and detaching the tubular portion from the cured material, thereby preparing a cured product of the epoxy resin composition in a cylindrical tubular shape;
cutting a surface part of the cured product at a predetermined thickness while rotating the cured product about the shaft portion relative to a cutting blade, thereby forming the cured product into a sheet shape so as to obtain an epoxy resin sheet having a long strip shape; and
removing the porogen from the epoxy resin sheet using a halogen-free solvent.
